(19) United States
(12) Patent Application Publication
(10) Pub. No.: US 2014/0270458 A1
(43) Pub. Date: Sep. 18, 2014

(54) Portable Blood Count Monitor

(71) Applicants: The Regents of The University of California, Oakland, CA (US); Tahoe Institute for Rural Health Research, LLC, Truckee, CA (US)

(72) Inventors: Zachary Smith, Sacramento, CA (US); Tingjuan Gao, Elk Grove, CA (US); Stephen Lane, Oakland, CA (US); Sebastian Wachmann-Hogiu, Sacramento, CA (US); Denis Dwyre, Davis, CA (US); Laurence Heifetz, Truckee, CA (US); James Hood, Truckee, CA (US); Dennis Matthews, Truckee, CA (US); Keith Tatsukawa, Truckee, CA (US)

(73) Assignees: The Regents of The University of California, Oakland, CA (US); Tahoe Institute for Rural Health Research, LLC, Truckee, CA (US)

(21) Appl. No.: 14/207,300

(22) Filed: Mar. 12, 2014

Related U.S. Application Data
(60) Provisional application No. 61/780,732, filed on Mar. 13, 2013.

(51) Int. Cl. G06K 9/00

(52) U.S. Cl. CPC G06K 9/00134
USPC 382/134

(57) ABSTRACT

Devices, systems, and methods are disclosed for determining the number and type of blood cells in a blood sample. The blood sample is collected and held in a slide. In the slide, the blood sample is separated and channeled into at least two sampling chambers, one for red blood cells, another for white blood cells, and optionally yet another for platelets. The sampling chambers have wetting agents, lysing agents, staining agents, or the like therein to mix with the blood and facilitate cell count. The slide is placed in a portable slide analyzer where the sampling chambers are illuminated and images of the sampling chambers are taken. These images are converted into electronic form and sent by a communications module of the slide analyzer to a remote external location where the images are analyzed to determine the number and type of blood cells in the blood sample.

### CROSS-REFERENCE

This application claims the benefit of U.S. Provisional Application No. 61/780,732, filed on Mar. 13, 2013, the contents of which is incorporated herein by reference in its entirety.

### STATEMENT AS TO FEDERALLY SPONSORED RESEARCH

This invention was made with partial government support under an Acceleration of Innovation Research grant awarded by the National Science Foundation (NSF Accelerating Innovation Research Grant No. 1127888, entitled “Creation of an Ecosystem for Biophotonic Innovation” and dated Aug. 1, 2011 to July 31, 2013), as well as from the Center for Biophotonics Science and Technology, a designated NSF Science and Technology Center managed by the University of California, Davis, under Cooperative Agreement No. PHY0120999. The government has certain rights in the invention.

### BACKGROUND OF THE INVENTION

The present disclosure relates to medical devices, systems, and methods. More specifically, the present disclosure relates to point-of-care health monitoring devices, particularly portable blood cell count monitors and methods used to count various types of blood cells, particularly red and white blood cells as well as platelets, and perform blood-related measurements such as hematocrit and hemoglobin level.

The current cost of healthcare in the United States is a large and rapidly growing burden on the national economy. Therefore, the development of new medical devices that can both improve the quality of care and reduce costs is desired. Many such devices are point-of-care devices. Point-of-care devices are devices that can be used where the patient or the patient's sample is not present in a clinic or a laboratory, which patients themselves can use to obtain medical information, and in some cases, may be monitored remotely by the patient's physician. For example, glucose monitors, which are used by diabetic patients to determine their own blood sugar levels, are commonly known and used point-of-care devices. Home or personal testing minimizes the need for monitoring tests to be performed at clinics or laboratories, has the potential for large and significant savings to the healthcare system, and improves patient accessibility to quality health care without the trouble and expense of travelling to and from their home to a clinic or laboratory. Such accessibility is important for rural patients who otherwise must undergo long and inconvenient commutes to visit a clinic or laboratory and in some cases when the patient is too ill to drive themselves.

One area for point-of-care monitoring is blood cell count or so-called complete blood count. Complete blood count (CBC) gives information about the cells in a patient's blood. The cells that circulate in the bloodstream are generally divided into three types: white blood cells (leukocytes), red blood cells (erythrocytes), and platelets (thrombocytes). Abnormally high or low counts of certain cell types may indicate the presence of many forms of disease. Hence, blood counts are amongst the most commonly performed tests in medicine, as they can provide an overview of a patient's health status as well as response to therapies.

Currently, CBC is most often performed through a visit to a clinic. A phlebotomist collects a blood sample by drawing blood into a test tube containing an anticoagulant to prevent the collected blood from clotting. This sample is then transported to a laboratory for analysis. Alternatively, the blood sample can be drawn off a finger prick using, for example, a Pasteur pipette.

CBC can be either automatically or manually performed. Currently, most blood samples are analyzed automatically. For such automatic analysis, a blood sample is first well mixed, usually with an anti-coagulant, and placed on a rack in an analyzer. The number of cells is counted using flow cytometry. A very small amount of the blood sample is aspirated through a narrow tube. Sensors count the number of cells passing through the tube and can identify the type of a cell passing through.

Because an automated cell counter samples and counts so many cells, the results can be very precise. However, certain abnormal cells in the blood may not be identified correctly, requiring manual review of the instrument's results and identification of any abnormal cells the instrument could not categorize.

In addition to counting, measuring, and analyzing red blood cells, white blood cells, and platelets, automated hematology analyzers can also measure the amount of hemoglobin contained in the blood cells. This information can be very helpful to a physician who, for example, may be trying to identify the cause of a patient's anemia. If the red cells are smaller or larger than normal, or if there is a lot of variation in the size of the red cells, this data can help guide the direction of further testing and expedite the diagnostic process so patients can get the treatment they need quickly.

Manual CBC is typically performed by viewing a slide prepared with a sample of the patient's blood (a blood film or a peripheral smear) under a microscope. Counting chambers that hold a specified volume of diluted blood (as there are far too many cells if it is not diluted) can be used to calculate the number of red and white cells per liter or microliter of blood. To identify the numbers of different white blood cells, a blood film can be made, and a large number of white blood cells (at least 100) can be counted. This count gives the percentage of cells that are of each type. By multiplying the percentage with the total number of white blood cells, the absolute number of each type of white cell can be obtained.

Manual counting can be useful in cases where automated analyzers cannot reliably count abnormal cells, such as those cells that may not be present in normal patients and can only be seen in peripheral blood with certain hematological conditions. Manual counting can be subject to sampling error because so few cells are counted compared with automated analysis.

Medical technologists examine blood film via a microscope for some CBCs, not only to find abnormal white cells, but also because variation in the shape of red cells can be an important diagnostic tool. Although automated analyzers give fast, reliable results regarding the number, average size, and variation in size of red blood cells, they often do not detect the shapes of the cells. Also, some normal patients' platelets will clump in EDTA (Ethylenediaminetetra acetic acid) anticoagulated blood, which can cause automatic analyses to give a falsely low platelet count. The technician viewing the slide in these cases may see clumps of platelets and can estimate if there are low, normal, or high number of platelets.

CBC is a procedure for many diagnostic reasons and indications, including infections, transplants, undergoing chemotherapy, cardiac disease, autoimmune disease, leukemia, anemia, inflammation, and for those interested in their general health status. CBCs are often performed for cancer patients. In the United States alone, there are at least ten million people with cancer, one and a half million new cases of cancer arise per year, and there are at least ten thousand oncologists practicing. More than fifty percent of cancer patients undergo chemotherapy. Chemotherapy patients often have CBC performed to monitor general health and the progression of the therapy itself. As discussed above, current methods of performing CBC require a visit to a clinic or a laboratory which can be inconvenient, if not unhealthy, to rural patients. Such methods also involve the use of expensive and cumbersome equipment with limited options for portable use and operations.

Moreover, obtaining a blood cell count test in a timely manner is crucial for chemotherapy patients. Most chemotherapy drugs are typically administered every 21 days and can cause myelosuppression, usually a 21 day cyclical fall and recovery in the patient's circulating blood cells that are made in the bone marrow. White blood cells and platelets live 10 days in circulation while red blood cells live 120 days. About 10 days after circulation, the number of white blood cells and platelets are usually at their lowest point or “nadir.” If the nadir is too low and the patient has a fever at that time, the patient is regarded as having “febrile neutropenia” and will typically require aggressive intravenous (IV) antibiotics, usually administered during an inpatient setting. Thus, medical oncologists routinely see their patients 10 days after chemotherapy to check the blood count numbers to determine the nadir, decide on the need for growth factor and/or antibiotic therapy, and anticipate the next chemotherapy dose 21 days after the first. If the patient has a fever within days 5 to 15 of the cycle, a blood count must be obtained to determine the need for an evaluation and therapy for a presumed infection. The decision for no antibiotics, oral antibiotics, IV antibiotics, and/or hospitalization is primarily based on this blood count test. Rural patients must travel long distances usually including emergency room visits just to get this crucial blood test.

For at least the above reasons, many oncologists are open to ordering point-of-care personal CBC monitors for their patients, especially if the data provided by such monitors is relatively complete and accurate. Many point-of-care personal blood count monitors have been developed and are commercially available. As mentioned above, current techniques for both automated and manual blood count can have a number of shortcomings. Many of these shortcomings can extend to current point-of-care personal blood count monitors. Many of these point-of-care personal blood count monitors are microfluidic devices which count the number of different types of cells using flow cytometry. As discussed above, certain abnormal cells in the blood may not be identified correctly using this method. Other point-of-care personal blood count monitors apply image analysis to images of a blood sample to count cell number and type. Such blood count monitors, however, can be less than ideal in many cases. For example, such monitors may only be able to count and analyze one type of cell. Also, the image analysis algorithms used may be less than optimal and may be prone to sampling error if too few samples are taken. Ease of use by unskilled operators is also a short-coming of current devices. Thus, improved devices, systems, and methods for performing complete blood count and analyzing blood cells in a portable, point-of-care platform that can be used by those who are not professionally trained including the patients themselves are desired.

### SUMMARY OF THE INVENTION

Aspects of the disclosure provide improved methods, systems, and devices for performing complete blood count and other blood and blood cell analysis procedures. The disclosure includes an inexpensive and transportable personal blood count monitor (PBCM) that can be taken home by a patient, easily set up, and routinely used to obtain and report specific blood count information, including critical blood cell count information. This information can be readout by the patient or communicated to another monitoring location or doctor. The personal blood count monitor can count red blood cells, white blood cells, platelets, and selected subsets of the aforementioned cells, as well as hemoglobin levels and hematocrit. Methods used by the personal blood count monitor for such counting are also disclosed, as are medical procedures performed by the patient to use the personal blood count monitor to track and analyze their blood count and chemotherapy progress.

Many of the blood count devices disclosed herein are easily transportable, easy to configure, and do not require advanced training or education to use. While many of the blood count devices disclosed herein are intended for home use for a patient, these devices may also be used in a hospital, a clinic, a doctor's office, or various other locations. Trained physicians, such as various oncologists (in medical oncology and hematology, radiation oncology, surgical oncology, gynecology oncology, pediatric oncology, etc.), infectious disease specialists, rheumatologists, transplantation teams, and physicians who need to follow a patient's red blood cell count (general surgeons, gastroenterologist, primary care providers, emergency medicine practitioners, orthopedic surgeons, otolaryngologists, neurosurgeons, etc.) may also use the blood count device. Many of the blood count devices disclosed herein use a relatively small amount of blood, for example, two to five microliters or in some cases even less, versus current blood count devices which can require 10 to 5,000 microliters. Many of the blood count devices disclosed herein can be calibrated against a traceable standard before a blood count measurement is performed.

Use of the blood count devices disclosed herein can have many benefits, including personalized myelosuppression profiles, personalized optimal chemotherapy dosing, avoidance of unnecessary and expensive white blood cell growth factor usage, decreased emergency visits, decreased unplanned hospitalizations for febrile neutropenia, decreased debility and death from treatment related infections or complications thereof, improved response rates to chemotherapy, etc.

Also disclosed are methods to be used by the patient to use the personal blood count monitor to track and analyze their blood count and chemotherapy progress. The personal blood count monitor may be taken home by the patient and used on the fifth, seventh, ninth, and eleventh days of each cycle of chemotherapy patient. The personal blood count monitor can be used by the patient or care-giver to perform a complete blood count or other blood count and report the results to a doctor's office where the results can be used to evaluate the patient's bone marrow response to the chemotherapy. The results can be manually reported via telephone or e-mail by the patient or automatically reported to a remote location using, for example, telemetry, a wide area network (WAN), the Internet, a mobile phone, or through e-mail that may be secure and encrypted. Generally, such automatic reporting can be achieved through a HIPAA certified secured transmission. A computerized system that receives the test results may save the results to a file that can become of permanent part of the patient's medical record. If the patient develops a fever at any time during a chemotherapy cycle, an additional blood count can be taken and reported. Based on the results of the blood count measurements, the doctor can decide on a course of treatment. For example, this treatment could range from having the patient go to an emergency room for evaluation and therapy, to prescribing antibiotics over the telephone, to starting the patient on white blood cell grown factors (e.g., filgastrim, pegfilgastrim), to having the patient take over the counter medications, and continuing to monitor the blood count. The costs of the various options may vary dramatically, and the use of the blood count monitor can be instrumental in providing the optimum medical care at the lowest cost. The personal blood count monitor can permit the doctor to optimize the chemotherapy treatment for a patient on a personalized basis and ultimately reduce the cost of the overall therapy.

An aspect of the disclosure provides a system for determining the number and type of blood cells in a sample. The system comprises a slide for collecting and holding a blood sample and a slide analyzer for receiving and analyzing the slide. The blood sample will be less than or equal to 5 uL and the slide comprises a blood inlet and at least two sampling chambers. The slide analyzer comprises a light source configured to project light onto the slide, a slide receiver for receiving and possibly translating the slide, an optics assembly, an image receiver for capturing one or more images from the at least two sampling chambers, and an image analyzer for analyzing the capture slide receiver is moveable. In at least some cases, the blood sample may have a volume of less than or equal to 2 uL. The system will typically be configured for use by a non-professionally trained user.

The sampling chambers may come preloaded with at least one of a surfactant, a dying agent, a lysing agent, a dry form reagent, a liquid reagent, or a predetermined volume of a diluent. Alternatively or in combination, the slide may comprise one or more reagent chambers for storing any one of the aforementioned agents. In some embodiments, the inner surfaces of the sampling chambers may be configured to be hydrophilic, for example, by being coated with a hydrophilic substance. Such hydrophilicity may facilitate the spreading out of very small volumes of liquid in the sampling chambers.

The slide may further comprise at least one channel in fluid communication with the sampling chambers. The slide may further comprise a suction port in fluid communication with the channel. The sampling chambers may comprise a first chamber for analyzing red blood cells and a second chamber for analyzing white blood cells. The channel and the dimensions of the first and second chambers may be configured so that a first predetermined volume of the blood sample enters into the first chamber and a second predetermined volume of the blood sample enters into the second chamber. In some embodiments, there may be a third chamber for analyzing platelets, which may be configured so that a third predetermined volume of the blood sample enters into the chamber. Alternatively, platelets may be counted by analysis of the first or second chambers.

The light source of the slide analyzer will typically be an LED. There may be two or more light sources. A first light source, the received slide, and the optics assembly may form a first optical path. A second light source and the received slide may form a second optical path at an angle to the first optical path. The second light source may be used when side scatter measurements of a sample are desired.

The optics assembly of the slide analyzer may be configured to automatically focus on a bottom surface of the sampling chambers. The optics assembly of the slide analyzer may further comprise one or more of a light filter assembly, a magnifier, and condenser optics. In many embodiments, the light filter assembly is moveable. The image receiver of the slide analyzer may comprise a CCD or CMOS detector array.

The image analyzer of the slide analyzer may comprise a processor adapted to analyze images taken by the image receiver to determine the number and type of blood cells present in the blood sample. The slide analyzer may further comprise a memory module coupled to the image processor for storing images taken from the sampling chambers through the optics assembly and the image receiver. The slide analyzer may further comprise a communications module coupled to the image processor for communicating the images taken or analysis data thereof to an external source. The communications module may communicate with the external source through at least one of telemetry, a satellite connection, a wireless connection, the Internet, e-mail, text messaging, or the like. The external source may comprise a processor adapted to analyze the images communicated from the communications module of the slide receiver.

Another aspect of the disclosure provides a method for determining the number and type of blood cells in a sample. A blood sample of less than or equal to 5 uL can be collected through an inlet of a slide. The blood sample can be channeled into a first sampling chamber and a second sampling chamber. The slide can be received in a slide analyzer. Images of the first and second sampling chambers of the slide analyzer may be acquired. The image of the first sampling chamber can be analyzed to determine at least one of the number and size of red blood cells in the blood sample. The image of the second sampling chamber can be analyzed to determine the number or type of white blood cells in the blood sample. In some cases, a single image of a sampling chamber may be analyzed for both red and white blood cells. The number of platelets may also be determined by analyzing the image of the first or second sampling chamber.

In many embodiments, the images of the first and second sampling chambers may be sent to an external location for analysis via a communications module of the slide analyzer. The communications module may communicate with the external source through at least one of telemetry, a satellite connection, a wireless connection, the Internet, e-mail, text messaging, or the like.

The slide analyzer typically comprises a movable slide receiver for receiving the slide. The image of the first or second sampling chamber may be acquired by moving the slide receiver so that the first or second sampling chamber, respectively, may be in optical alignment with an optics assembly of the slide assembly. The slide may be moved by linear translation or rotation, often depending on the configuration of the slide.

In many embodiments, the blood sample can be further channeled into a third chamber. An image of the third sampling chamber may be acquired and analyzed to determine the number of platelets in the blood sample. Alternatively or in combination, the first or second sampling chamber may be imaged and analyzed to determine the number of platelets in the blood sample. Again, the image of the third sampling chamber may be sent to the external location with a communications module of the slide analyzer, where that image may be analyzed with a processor.

The blood analyzer needs only a small volume of blood to complete an analysis. In some cases, the collected blood sample may have a volume of less than or equal to 2 uL. A first predetermined volume of the blood sample may be channeled into the first sampling chamber and a second predetermined volume of the blood sample may be channeled into the second sampling chamber. Imaging optics of the slide analyzer may be automatically focused on the bottom surfaces of the first and second sampling chambers before image acquisition. While the volumes of the blood sampled may be channeled into their respective sampling chambers, at least one of a surfactant, a dying agent, a lysing agent, a dry form reagent, a liquid reagent, or a predetermined volume of a diluents present in the first or second chambers may be mixed with the blood samples.

The analysis of white blood cells may comprise one or more steps of lysing red blood cells, staining the white blood cells, taking images of the white blood cells, and analyzing the images to determine white blood cell number in addition to subpopulation numbers and percentages. The red blood cells in the second chamber will typically be lysed with a lysing agent before the image of the second sampling chamber may be analyzed to facilitate the counting of white blood cells. The lysing agent may be selected from the group comprising SDS, saponins, snake venom, quaternary ammonium salts, triton-X, and the like. The dying agent may comprise a nucleic acid staining agent. To determine the number or type of white blood cells in the blood sample, the white blood cells in the second sampling chamber may be stained with the nucleic acid staining agent and a relationship between fluorescence at a first color with fluorescence at a second color for individual white cells may be determined. White blood cells may then be typed based on this relationship, i.e., particular types of white blood cells may fall within particular ranges of fluorescent intensity at the first and second wavelengths or wavelength ranges. Additional dimensions of analysis may also be implemented to differentiate cell types and properties. For example, fluorescent intensities at other wavelengths or wavelength ranges as well as forward and side light scattering may be measured. Also, platelets may also be identified as small, dim objects with low fluorescent intensities. Thus, the number of platelets may also be determined along with the number of white blood cells. The nucleic acid staining agent may comprise one or more of acridine orange, thiozole orange, acridine red, 7-AAD, LDS 751, and hydroxystilbamidine. Fixatives may be added to improve the staining of platelets.

The analysis of red blood cells may comprise one or more steps of sphering the red blood cells (i.e., treating the red blood cells with a reagent such that the red blood cells change into a spherical shape from their normal bi-concave disk shape), imaging the red blood cells, analyzing the image for red blood cell count and size distribution, and various calculations to determine one or more clinically important parameters. By sphering the red blood cells, the cells can readily be identified as spherical objects in an acquired image. The size and size distribution of these cells can also be measured and analyzed, for example for mean cell volume (MCV) and red blood cell distribution width (RDW). Hematocrit may then be calculated based on the aforementioned parameters and the predetermined volume of the imaged sample. The sample may also be imaged using multiple wavelengths of light and absorption can be measured and used to determine hemoglobin levels.

Other procedures to type and count blood cells, including red blood cells, white blood cells, and platelets, are also contemplated. For example, cell-like objects, abnormal cells, and abnormally shaped cells in a captured image may be identified by matching such objects to one or more cell templates.

Often, the first and second sampling chambers will be illuminated before or during the acquiring of the images of the first and second sampling chambers. Also, the slide analyzer may be calibrated before acquiring the images of the first and second sampling chambers. For example, an image of one or more calibration chambers of the slide analyzer may be taken and analyzed. The number or type of cell reproductions in the calibration chamber may be analyzed and compared with a predetermined number or type to determine the accuracy of the slide analyzer.

Additional aspects and advantages of the disclosure will become readily apparent to those skilled in this art from the following description, wherein only illustrative embodiments of the present disclosure are shown and described. As will be realized, the present disclosure is capable of other and different exemplary implementations, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows a system for performing blood count analysis according to an embodiment of the invention;

FIG. 2A shows a blood collection and analysis slide according to an embodiment of the invention;

FIG. 2B shows a calibration slide according to another embodiment of the invention;

FIG. 2C shows a blood collection and analysis slide with calibration features according to yet another embodiment of the invention;

FIG. 3 shows a block diagram of the system for performing blood count analysis according to an embodiment of the invention;

FIGS. 4A to 4C show a movable slide receptor and a movable filter assembly of the system of FIG. 3 in use;

FIG. 5A is a flowchart of a process to count and determine the type of white blood cells in a blood sample according to an embodiment of the invention;

FIG. 5B is a simplified graph of data taken during the process of FIG. 5A to count and determine the type of white blood cells in the blood sample;

FIG. 6 is a flowchart of a process to count the number of red blood cells in a blood sample according to an embodiment of the invention;

FIG. 7 shows a block diagram of a system for performing blood count analysis according to another embodiment of the invention;

FIG. 8 shows top view of a blood collection and analysis slide used with the system of FIG. 7;

FIG. 9 shows a finger rest and blood collector used with the system of FIG. 7; and

FIG. 10 shows a perspective view of the exterior of the system of FIG. 7.

### DETAILED DESCRIPTION OF THE INVENTION

Aspects of the invention provide improved devices, systems, and methods for performing blood count measurements. Various aspects of the invention described herein may be applied to any of the particular applications set forth below or for any other types of biological analysis systems. It shall be understood that different aspects of the invention can be appreciated individually, collectively, or in combination with each other.

1. System Overview

FIG. 1 shows a system 10 for performing blood count analysis. The system 10 comprises a blood collection and holding slide 100 and an automated portable slide analyzer 150. The automated portable slide analyzer 150 comprises a display 160 and a control panel 170.

The slide 100 will typically be relatively low in cost, be optically clear, and may comprise two optically clear glass, plastic, or polycarbonate substrates that may be separated by 4 to 100 microns with one hole for the insertion of blood. As shown in FIG. 1, the slide 100 can be rectangular in shape but instead may also be circular, elliptical, round, or have other shapes so as to reduce overall costs. The space between these substrates may define one or more sampling chambers and may be pre-prepared with a dye solution, a lysing solution, and other compounds that facilitate analysis. Microfluidics and capillary action may be used to control the flow of a blood sample into the test chambers. The slide 100 collects and holds blood from a blood droplet D collected from a finger prick P on a user's finger F. Typically, the volume of blood collected by and held by the slide 100 will be less than or equal to 5 uL or less than or equal to 2 uL. The surfaces of the various sampling chambers of slide 100 may be pre-treated in various ways to be hydrophilic. Hydrophilic surfaces can facilitate the channeling of blood samples into the various chambers and can also allow very small volumes of blood or liquid to spread out over relatively large areas, for example, if a sampling chamber has a relatively large area and a relatively small height.

Once a blood sample is collected by the slide 100, the slide 100 can be placed into the portable slide analyzer 150, more specifically the slide receiver 155, for analysis. Results of the analysis may be shown on the display 160 of the slide analyzer 150. The slide analyzer may be operated by the control panel 170 but operation of the system 10 may also be automated such that operating the system 10 using the control panel 170 may not be necessary.

FIG. 2A to FIG. 2C show various embodiments of slides that may be used with the portable slide analyzer 150. As shown in FIG. 2A, the slide 100 comprises a blood inlet 105, a fluid channel 110, a suction port 130, and at least two sampling chambers. As shown in FIG. 2A, the slide 100 comprises a first sampling chamber 115, a second sampling chamber 120, and a third sampling chamber 125. As shown in FIGS. 2A to 2C, the sampling chambers 115, 120, and 125 may be rectangular in shape but they may instead also be circular, elliptical, round, or have other shapes so as to reduce overall costs. The suction port 130 may be coupled to a suction source which facilitates the channeling of the blood sample from the blood inlet 105 into the fluid channel 110 and into the sampling chambers 115, 120, and 125. In many embodiments, blood may be diverted from the blood inlet 105 into the sampling chambers 115, 120, and 125 by capillary action or a combination of both capillary action and suction. The slide 100 will also typically comprise a marking 102 to indicate the proper orientation and direction of the slide 100 as it is placed into the slide analyzer 150. Each sampling chamber may be analyzed for different formed elements of blood, for example, different types of blood cells. The first sampling chamber 115 may be for the analysis of red blood cells, the second sampling chamber 120 may be for the analysis of white blood cells, and the third sampling chamber 125 may be for the analysis of platelets.

Each sampling chamber may be provided with one or more reagents in dry form. These reagents mix with the blood channeled into the sampling chambers 115, 120, or 125 to facilitate the counting of blood cells. The first sampling chamber 115 may contain a first dry form reagent 135, the second sampling chamber 120 may contain a second dry form reagent 140, and the third sampling chamber 125 may contain a third dry form reagent 145. In some embodiments, one or more of the reagents provided in the sampling chambers may instead be in liquid form instead of in dry form. The first dry form reagent 135 may include a surfactant to facilitate the counting of red blood cells as further described below. In some embodiments, the first sampling chamber 115 may be selected for the count of red blood cells and may contain a diluent, a dye, and other chemical compounds. Alternatively or in combination, the first sampling chamber 115 may be in fluid communication with another chamber that provides diluents to the first sampling chamber 115. The portion of the blood sample in the first sampling chamber 115 for red blood cell analysis may be diluted in any range between 1:1 and 1:10. In many embodiments, the volume of diluents provided may depend on the size of the sampling chamber. For example, a larger chamber may require a larger dilution factor. In some embodiments, dilution may not even be required. The second dry form reagent 140 may include a lysing agent for lysing red blood cells, for example, such as SDS, saponins, snake venom, quaternary ammonium salts, triton-X, and the like. The second dry form reagent 140 may further include a fluorophore compound, for example, a nucleic acid stain such as Acridine Orange, 7-AAD, LDS 751, or hydroxystilbamidine, to facilitate the counting and typing of white blood cells as further described below. Fixatives may be added to improve the staining of platelets.

Before analyzing the slide 100, the slide analyzer 150 may be calibrated. FIG. 2B shows a calibration slide 101. The calibration slide 101 may comprise one or more calibration chambers, for example, a first calibration chamber 116, a second calibration chamber 121, and a third calibration chamber 126. A calibration chamber 116, 121, or 126 may include a predetermined number of cell reproductions or other possible standards with the same size and fluorescent properties, for example, polystyrene beads or cell reproductions that may be painted or printed onto the bottom of the calibration chamber 116, 121, or 126. The calibration chamber 116 may include a predetermined number of reproductions of red blood cells, the calibration chamber 121 may include a predetermined number of reproductions of white bloods cells, and the calibration chamber 126 may include a predetermined number of reproductions of platelets. To calibrate the slide analyzer 150, the slide analyzer 150 takes an image of the bottom of a calibration chamber, the image can be analyzed to count the number of cell reproductions, the counted number can be compared to the predetermined number, and the slide analyzer 150 may be adjusted as necessary so that the counted number approximates the predetermined number. Like with the slide 100, the calibration slide 101 may also typically comprise a marking 102 to indicate the proper orientation and direction of the slide 100 as it is placed into the slide analyzer 150.

In some embodiments, calibration and blood sample analysis may be performed with the same slide. FIG. 2C shows a blood collection and analysis slide 100a appropriate for such use. The slide 100a comprises an orientation and directionality indicator marking 102, a blood inlet 105, a main fluid channel 110, a first sampling chamber 115 having therein a first dry form reagent 135, a second sampling chamber 120 having therein a second dry form reagent 140, a third sampling chamber 125 having therein a third dry form reagent 145, a suction port 130, a first calibration chamber 116, a second calibration chamber 121, and a third calibration chamber 126.

FIG. 3 shows a block diagram of the system 10 for performing blood count analysis. As shown in FIG. 3, a slide 100 has been inserted into the slide receiver 155 of the slide analyzer 150. The slide receiver 155 may be automatically moveable such that different sampling chambers can be analyzed at different times. Under instructions from a processor 350 of the slide analyzer 150, the slide receiver 155 can move the slide 100 so that the first sampling chamber 115, the second sampling chamber 120, or the third sampling chamber 125 may be analyzed. Typically, the slide 100 may be moved by translation. However, a slide may instead be rotated as described below or the optics may instead be moved, such as by rotation or translation or scanning, while the slide remains stationary. If a slide inserted into the slide analyzer 150 has any calibration elements, the slide receiver 155 can move this slide so that any desired calibration chamber can be analyzed. The slide receiver 155 may comprise a micromanipulator capable of moving the slide receiver 155 in small, precise steps. Preferably, the slide 100 can be sealed or otherwise fluidly isolated from the slide analyzer 150 to minimize the risk of contamination of the slide analyzer 150 so that the slide analyzer 150 can be repeatedly used with different slides 100. The slide analyzer 150 may also be configured to withstand sterilization and cleaning, for example by exposure to UV or other radiation or to various cleaning and sterilization chemicals, without adversely affecting the function of the slide analyzer 150. For example, the various components of the slide analyzer 150 may have protective coatings or may be covered by various shells. In at least some cases, these shells may be removed and replaced.

The slide analyzer 150 further comprises a primary light source 300, an optics assembly 330, and an image capture element 345, which may all be in alignment with each other. As shown in FIG. 3, the primary light source 300 may be positioned immediately below the slide receiver 155. The slide analyzer 150 further comprises a second light source 305 positioned laterally of the slide receiver 155. The second light source 305 may be utilized, for example, when side scatter measurements of any of the sampling chambers of the slide 100 may be desired. The primary light source 300 illuminates a sampling chamber (for example, the sampling chamber 120 as shown in FIG. 3). Both the primary light source 300 and the secondary light source 305 may further comprise condenser optics 300a and 305a, respectively, to facilitate the illumination of the slide and its components, such as by facilitating the formation of a parallel illumination beam. The movable filter assembly 310 may comprise one or more filters, such as color filters and spatial filters. Light from the illuminated sampling chamber can pass through one of the filters of the moveable filter assembly 310. As shown in FIG. 3, the movable filter assembly 310 comprises a first filter 315, a second filter 320, and a third filter 325. The first filter 315 may be a red filter, the second filter 320 may be a green filter, and the third filter 325 may be a spatial filter for light scatter measurements taken, for example, when a forward scatter measurement performed using the primary light source 300 or a side scatter measurement performed using the secondary light source 305 is desired. The moveable filter assembly 310 can be moved through instructions from the processor 350 so that a desired filter may be selected to facilitate image capture and analysis. The moveable filter assembly 310 may comprise a micromanipulator capable of moving the moveable filter assembly 310 in small, precise steps. The moveable filter assembly 310 will typically be a component of the optics assembly 330. Before passing through a desired filter, light from the sampling chamber may first pass through the other elements of the optics assembly 330. The optics assembly 330 comprises at least two lenses, a first lens 335 and a second lens 340, which can be used to magnify any image taken and adjust the focal plane of the optics assembly 330. Images, for example, can be magnified up to about 50-500×. As shown in FIG. 3, the moveable filter assembly 310 is disposed between the first lens 335 and the second lens 340, with light first passing through the first lens 335 before passing the filter assembly 310. The image from the sampling chamber 120 can be taken by the image capture element 345 after the light of the image passes through the optics assembly 330. The image capture element 345 may comprise a CCD or CMOS detector array, for example, a low-cost, high-resolution CCD. The system 10 may further comprise a cooling element 345c for cooling the image capture element 345. Also, the image capture element 345 and the optics assembly 330 may in many cases be moveable as a unit so that they can scan across various fields in a focal plane of a sampling chamber.

The slide analyzer 150 further comprises a processor 350, a memory module 355, a communications module 360, the display 160, and the control panel 170. User input can be entered into the slide analyzer 150 through the control panel 170 which in turn sends instructions to the processor 350. The processor 350 can send and receive various instructions, for example, for adjusting the position of the slide receiver 155 to determine which sampling chamber to analyze, for adjusting the position of the filter assembly 310 to determine which light filter to use, for adjusting the magnification and focal plane of the optics assembly 330, for instructing the image capture element 345 to capture one or more images, etc. The processor 350 can be coupled to a memory module 355 for the storage of captured images. The memory module 355 may comprise a random-access memory (RAM), a flash memory, a hard drive, or other volatile or non-volatile memory.

The processor 350 can further be coupled to a communications module 360 which can communicate electronic versions of the captured images to various external sources such as a distributed-computing or cloud-computing based analysis service 365 or any other external analysis device 370 such as a server, desktop personal computer, laptop computer, tablet computer, mobile phone, or the like. Generally, the communications module 360 will communicate with the external device using a HIPAA certified secure transmission. The electrical signals representing the color and physical size of each blood cell can be analyzed using image analysis software to determine the type of blood cell being viewed. Other types of analysis may also be applied. For example, abnormalities in the red blood cells such as nucleated red blood cells or deformed red blood cells may also be detected. Analysis data may also be permanently and automatically recorded in the patient's health records.

The communications module 360 may communicate via various methods, including but not limited to telemetry, a satellite connection, a wireless connection, the Internet, e-mail, text messaging, or the like. Generally, such communication will be achieved through a HIPAA certified secure transmission. After the external source has analyzed the communicated image data, it can return analysis data to the communications module 360. The processor 350 can then have the analysis data displayed on the display 160. In some embodiments, the processor 350 may be programmed to perform at least some or even all of the analysis on the captured images itself and then display the analysis results on the display 160. Such internal analysis may be preferable in cases where the user does not have access to any high-speed telecommunications network. After the slide 100 has been analyzed, the slide 100 can be removed from the slide receiver 155 and disposed of as non-toxic waste. A receptacle may be provided and used for the disposal of slides where the blood sample cannot be considered non-toxic waste. The processor 350 may also be coupled to a system monitor 375 which may monitor and control the temperature within the slide analyzer 150.

As discussed above, the filter assembly 310 and the slide receiver 155 with the slide 100 can be selectively moved to select the particular light filter used and the particular sampling chamber to be analyzed. As shown in FIG. 4A, the slide receiver 155 can be positioned so that the third sampling chamber 125 can be analyzed and the filter assembly 310 can be positioned so that the second filter 320 can be used. As shown in FIG. 4B, the filter assembly 310 can be moved in a direction 401 so that the third filter 325 may instead being used and the slide receiver 155 can be moved in a direction 404 so that the second sampling chamber 120 may be analyzed. As shown in FIG. 4C, the filter assembly 310 can be moved in a direction 407 so that the first filter 315 may be used and the slide receiver 155 can be moved in a direction 410 so that the first sampling chamber 115 may be analyzed. Additionally, any number of combinations of particular filters on the filter assembly 310 and particular sampling chambers of the slide 100 can be moved into optical alignment so a particular image may be taken for analysis.

2. Blood Sample Analysis

Methods of counting or typing various blood cells, as well as analyzing blood samples, will now be described. While individual methods of counting particular types of blood cells—red blood cells, white blood cells, and platelets, and analyzing blood samples, for example, for hemoglobin levels, hematocrit, etc. may be described, these methods can be used in combination with the system 10 such that a single sample of blood placed into a slide 100 can be analyzed for each type of blood cell or each desired measurement parameter.

FIG. 5A is a flowchart of a process 500 to count and determine the type of white blood cells in a blood sample. While this particular process 500 may be described in detail below, many other processes to count and determine the type of white blood cells in a blood sample may be instead used with system 10. Various steps may also be added or omitted without departing from the scope of the process 500. Processes similar to process 500, including similarities to one or more of the below steps, may also be used to determine the count and type of other types of blood cells such as red blood cells and platelets.

In a step 500, a blood sample may be obtained. As discussed above, the blood sample may be obtained by a finger prick. The sample may have a relatively small volume, for example, less than or equal to 5 uL or less than or equal to 2 uL. The sample may be collected by and held in a slide 100 described above. In a step 510, at least a portion of the sample can be channeled into a white blood cell sampling chamber, for example, the second sampling chamber 120 described above. In a step 515, the sample in the sampling chamber can be stained, for example, by a dry form reagent pre-included in the sampling chamber as described above. The white blood cells may be stained, for example, by a nucleic acid stain such as acridine orange, thiozole orange, acridine red, 7-AAD, LDS 751, hydroxystilbamidine, or the like. To facilitate the counting of the white blood cells, a lysing agent may be pre-included in the sampling chamber. This lysing agent lyses red blood cells so that mostly, preferably all of the white blood cells will remain most prominently visible in the sample to be analyzed. The lysing agent may comprise SDS, saponins, snake venom, quaternary ammonium salts, triton-X, and the like. In a step 520, the stained sample can be illuminated, for example, with a light source 300 as described above. In a step 525, the fluorescent response of the stained sample at a first wavelength or wavelength range can be measured. For example, the first wavelength may be at a range appropriate for recording fluorescence in a desired domain, for the green domain with a wavelength band of 510-535 nm, and the fluorescent response at these wavelengths may be indicative of the concentration of DNA in a particular cell or group of cells. In a step 530, the fluorescent response of the stained sample at a second wavelength or wavelength range can be measured. For example, the second wavelength may be at a range appropriate for recording fluorescence in another desired domain, for example the red domain with a wavelength band of 635 to 660 nm, and the fluorescent response at this wavelength may be indicative of the concentration of RNA in a particular cell or group of cells. The fluorescent emission of the stained sample at further wavelengths using one or more additional light sources emitting at different wavelengths may also be measured as well as scattering response at various angles. In a step 535, imaged cells may be grouped by their fluorescent responses as well as scattering responses in at least some cases. For example, a group of cells with a green and red fluorescent response at one range may be grouped as one type of white blood cell while a second group of cells with a green and red fluorescent response at a second range may be grouped as another type of white blood cell. In a step 540, the count and type of white blood cells may be determined. For example, such a determination can be made based on an individual cell's ratio of stained DNA to stained RNA.

The measurement of fluorescent response in steps 525 and 530 can be taken in many ways. Typically, magnified images of the stained sample may be taken. In some cases, images of a plurality of fields can be taken and then stitched together digitally to create a whole image. There will typically be multiple whole images of an entire sampling field for fluorescent responses at different wavelengths, i.e., different channels. To determine whether a particular object in the whole image is a white blood cell, the following process may be performed. First, a particular channel may be registered. Then, the background from a particular channel may be subtracted. For example, the mean or median fluorescent intensity from a particular whole image can be subtracted from the whole image. Cell regions can then be identified using thresholding or watershed segmentation, and the mean channel intensities for each cell can be computed. Once a cell is identified, it can be counted. White blood cells in a whole image may also instead be identified by comparison with various cell templates.

Once the number of white blood cells is counted, subpopulation numbers of cells and related percentages may be determined. As described above, different subpopulations of white blood cells may be grouped according to their range of fluorescent responses across two or more frequencies. Further, mixed Gaussian modeling of two-dimensional histograms of green and red fluorescent intensities may also be performed and analyzed. Higher dimension histograms, for example, including further fluorescent intensities at different wavelengths or wavelength ranges and light scatter measurements, may also be created and analyzed. To analyze the data, principal component decomposition on this multidimensional data may be performed and the one or two lowest dimensions may be fit to Gaussian models, skew-T models, log-normal models, or others. Various data mining techniques and algorithms, such as supervised or unsupervised clustering approaches, may also be applied to determine cell subpopulation numbers and percentages.

FIG. 5B is a simplified graph 550 of data taken during the process 500 being used to count and determine the type of white blood cells in the blood sample. Individual cells, or representations thereof, can be placed on the graph 550 based on the amount of green fluorescent response and red fluorescent response. In the graph 550, the x-axis represents the level of green fluorescent response and the y-axis represents the level of red fluorescent response. The cells placed on the graph 550 can be divided into a plurality of groups based on their ranges of fluorescent responses, for example, a first group 555, a second group 560, and a third group 565. For example, the first group 555 may represent the number of neutrophils, the second group 560 may represent the number of lymphocytes, and the third group 565 may represent the number of monocytes. In at least some cases, there may be a fourth group 570 representative of the number of platelets. Platelets may be identified as dim, small objects that may be distinguishable from white blood cells based on both intensity and size. As discussed above, higher dimension graphs may also be created based on the two dimensions just described (red and green fluorescent response) in addition to others.

FIG. 6 is a flowchart of a process 600 to count the number of red blood cells in a blood sample. While this particular process 600 is described in detail below, many other processes to count the number of red blood cells in a blood sample may be instead or in combination used with system 10. Various steps may also be added or omitted without departing from the scope of the process 600. For example, size measurements of the red blood cells may be taken, hemoglobin levels may be measured such as by illuminating the sample using various colors of light, and hematocrit may be measured. In a step 605, a blood sample can be obtained. As discussed above, the blood sample may be obtained by a finger prick. The sample may have a relatively small volume, for example, less than or equal to 5 uL or less than or equal to 2 uL. The sample may be collected by and held in a slide 100 described above. In a step 610, at least a portion of the sample can be channeled into a red blood cell sampling chamber, for example, the first sampling chamber 115 described above. In a step 615, the sample can be wet, for example, by a surfactant in dry form such as reagent 135 described above. With a surfactant in the blood in the red blood cell sampling chamber, red blood cells at the bottom surface of the sampling chamber will form into a rounded, spherical shape instead of their normal bi-concave disc shape. In a step 620, an image can be taken of the sampling chamber. The sampling chamber may be imaged at one or more wavelengths or wavelength ranges, often depending on the type of measurement desired. The rounded red blood cells at the bottom surface of the sampling chamber can be readily identified by their shape, for example, via template matching. Typically, the image taken in step 620 comprises a large format image, preferably comprising more than 100,000 sphered red blood cells at an appropriate dilution. In a step 625, the number of red blood cells identified can be counted to determine red blood cell count (RBC).

Various other blood related parameters may also be obtained using the above red blood cell counting procedure. For example, a Fourier transform or other mathematical transform may be performed on the large field image described above to obtain a diffraction pattern. This diffraction pattern may be analyzed to determine a distribution of cell radii. Based on the cell radii, the volume distribution of the red blood cells can be determined and various clinically significant parameters such as mean cell volume (MCV) and red blood cell distribution width (RDW) can be determined. As the volume of the sample size will typically be known, MCV and RBC can then be used to determine hematocrit (HCT). Hemoglobin levels, for example, the mean corpuscular hemoglobin concentration (MCHC), can also be extracted from image data analysis. For example, the sample may be imaged using multiple wavelengths or wavelength ranges of light and the average absorption of light by the red blood cells may be computed. MCHC can then be computed using a Beer-Lambert Law model based on the known spherical shape of the blood cells and the known MCV. As another example, spectroscopy may also be used to determine MCHC. For example, the sampling chamber may be illuminated with white light, the average spectrum passing through the chamber may be detected using a spectrometer, and HGB concentration can be estimated using a known absorption spectrum. The determination of various other clinically important parameters and measurements based on image analysis are also contemplated.

Platelets may also be counted in various ways. For example, the number of platelets in a sample may be counted as a step in the process of counting the number of white blood cells as described above. The various cells in a sample may be dyed with a nucleic acid stain such as acridine orange, thiozole orange, acridine red, 7-AAD, LDS 751, hydroxystilbamidine, or the like. Fluorescent images of the sample may be taken and analyzed. Platelets in these images identified as dim, small objects that may be distinguishable from white blood cells based on fluorescent intensity and size.

Other ways of counting platelets are also contemplated. For example, forward and side-scatter information may be analyzed. Platelets will typically have relatively isotropic scattering signatures compared to red blood cells and white blood cells. As another example, template matching, such as for bright field or dark field images of unstained blood may also be performed. At high magnifications, platelets may be visible as tiny dust-like objects distinguishable from other cells based on size.

3. Other Embodiments

Numerous variations, changes, and substitutions can be made to the systems, devices, and methods of the disclosure without departing from the scope thereof. FIG. 7 shows a block diagram of a system 10A for performing blood count analysis according to another embodiment of the invention. The system 10A, particularly the automated portable slide analyzer 150A, may be similar in many respects and may comprise similar elements to the system 10 and the automated portable slide analyzer 150, respectively, described above with reference to FIG. 3. In the system 10A, however, the blood collection and analysis slide 100R moves via rotation instead of translation. The system 10A further comprises a motor 100M configured to couple to the slide 100R and rotate the slide 100R for visualizing a desired sampling chamber of the slide 100R. As shown in FIG. 7, the motor 100M has aligned the sampling chamber 115R of the slide 100R with the light sources 300, 305 as well as the optics assembly 330. Under instructions from the processor 350, the motor 100M may rotate the slide 100R so that the sampling chamber 120R can be instead aligned with these components so that the sampling chamber 120R can be analyzed instead. The motor 100M may also rotate the slide 100R so that various other features, such as further sampling or calibration chambers, of the slide 100R can be visualized for analysis.

Other components of the system 10A may be moved by rotation instead of translation. As shown in FIG. 7, for example, the system 10A may further comprise a motor 310M coupled to a rotatable filter assembly 310R. As shown in FIG. 7, the motor 310M has aligned the filter 315R of the filter assembly 3 lOR within the optics assembly 330, the sampling chamber 115R to be imaged and analyzed, and the light sources 300 and 305. Under instructions from the processor 350, the motor 310M may rotate the filter assembly 31OR so that the filter 320R may instead be aligned with these components. The motor 310M may also rotate the filter assembly 310R so that various other features, such as other filters, of the filter assembly 310R may be aligned with the optical components of the system 10A.

In some embodiments, the automated portable slide analyzer 150A may further comprise an integrated blood collector 380. The integrated blood collector 380 may find use particular use for patients and users of the system 10A who may not be medically trained and may have difficulty collecting their own blood. As shown in FIG. 9, the integrated blood collector 380 may comprise a finger rest having a stylet 380L for pricking the user's finger F and collecting blood therefrom. To avoid contamination, the integrated blood collector 380 may be mounted on the exterior of the automated portable slide analyzer 150A as shown in FIG. 10. As shown in the block diagram of FIG. 7, the integrated blood collector 380 may be coupled to the slide 100R to channel collected blood into the slide 100R. Once blood is collected for a round of analysis, the integrated blood collector 380 may be removed from the automated portable slide analyzer 150A and replaced with another integrated blood collector 380.

Referring back now to the rotatable slide 100R of the system 10A, FIG. 8 shows a top view of a blood collection and analysis slide 100R. The slide 100R comprises a central hub 800 for coupling to the motor 100M to the slide 100R so that the slide 100R can rotate about the central hub 800. The slide 100R will typically be disposable, be used to collect and analyze blood samples, store various reagents, and generally have many similar functions to the translatable slide 100 described above. Additionally, the motor 100M may rotate the slide 100R to facilitate mixing and even provide for physical separation of various blood components. The motor 100M may also rotate the slide 100R in small and precise increments such that various fields in the focal plane of the sampling chambers 115R and 120R can be imaged sequentially, and in many cases without having to scan the optical components of the system 10A, such as the optics assembly 330, the filter assembly 310 or 310R, and the image capture element 345. As discussed above, the images of the various fields can be stitched together digitally to form a large field image of the entire sampling chamber that can be analyzed.

The slide 100R can comprise various components similar to those of the translated slide 100 but adapted for use with a circular, rotated slide 100R. For example, the slide 100R comprises an inlet 130R, a mixing chamber 815, a first reagent storage chamber 805, a second reagent storage chamber 810, valves 820, a first sampling chamber 115R, a second sampling chamber 120R, a first calibration chamber 116R, and a second calibration chamber 121R. The first and second calibration chambers 116R and 121R may be similar to the first and second calibration chambers 116 and 121, respectively, described above and may comprise cell reproductions such as those of white blood cells and red blood cells. The first and second reagent storage chambers 805 and 810 may contain various reagents, for example, one or more of surfactants, dying agents, lysing agents, dry form reagents, liquid reagents, or predetermined volumes of a diluents. The valves 820 may separate the reagent storage chambers 805 and 810 and the mixing chamber 815 from the first and second sampling chambers 115R and 120R. After blood is collected through inlet 130R, rotation of the slide 100R may generate centrifugal forces that extract the reagents, and diluents in some cases, from the reagent storage chambers 805 and 810 into the mixing chamber 815 where the reagents, blood, and diluents in some cases mix. Centrifugal forces can also be used to separate blood components. The valves 820 may then be opened for this mix to be channeled into the first and second sampling chambers 115R and 120R. In some cases, one or more of the sampling chambers may include various reagents as well. For example, the first sampling chamber 115R may be for analyzing white blood cells and may include a lysing agent to lyse red blood cells to facilitate white blood cell analysis. The valve 820 can prevent the lysing agent from passing from the first sampling chamber 115R into the mixing chamber 815. While the channeling of liquids using centrifugal forces may be described, many other ways of manipulating samples may also be used with the rotatable slide 100R, including but not limited to the use of suction, micro fluidics, pressure mechanisms, capillary action, electrophoresis, and others. Blood samples may also be imaged in many other ways aside from those involving the translation or rotation of a slide. For example, images of a particular section of a flow channel can be taken as the blood sample passes through the flow channel. In this case, the optics and flow channel of the blood analyzer can remain stationary while the blood sample is in motion within the flow channel.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A system for determining the number and type of blood cells in a sample, the system comprising:
a slide for collecting and holding a blood sample of less than or equal to 5 uL, wherein the slide comprises a blood inlet and at least two sampling chambers; and
a slide analyzer for receiving and analyzing the slide, the slide analyzer comprising a light source configured to project light onto the slide, a slide receiver for receiving the slide, an optics assembly, an image receiver for capturing one or more images from the at least two sampling chambers, and an image analyzer for analyzing the captured images to determine the number and type of blood cells in the sample.

2. The system of claim 1, wherein the blood sample has a volume of less than or equal to 2 uL.

3. The system of claim 1, wherein the at least two chambers comprises at least one of a surfactant, a dying agent, a lysing agent, a dry form reagent, a liquid reagent, or a predetermined volume of a diluent.

4. The system of claim 1, wherein the slide further comprises at least one channel in fluid communication with the at least two sampling chambers.

5. The system of claim 4, wherein the slide further comprises a suction port in fluid communication with the at least one channel.

6. The system of claim 4, wherein the at least two sampling chambers comprises a first chamber for analyzing red blood cells and a second chamber for analyzing white blood cells.

7. The system of claim 6, wherein the at least one channel and the dimensions of the first and second chambers are configured so that a first predetermined volume of the blood sample enters into the first chamber and a second predetermined volume of the blood sample enters into the second chamber.

8. The system of claim 4, wherein the at least two sampling chambers further comprises a third chamber for analyzing platelets.

9. The system of claim 8, wherein the at least one channel and the dimensions of the first, second, and third chambers are configured so that a first predetermined volume of the blood sample enters into the first chamber, a second predetermined volume of the blood sample enters into the second chamber, and a third predetermined volume of the blood sample enters into the third chamber.

10. The system of claim 1, wherein the light source of the slide analyzer comprises an LED.

11. The system of claim 1, wherein the light source of the slide analyzer comprises a first light source and a second light source,
wherein the first light source, the received slide, and the optics assembly form a first optical path, and
wherein the second light source and the received slide form a second optical path at an angle to the first optical path.

12. The system of claim 1, wherein the optics assembly of the slide analyzer is configured to automatically focus on a bottom surface of the at least two sampling chambers.

13. The system of claim 1, wherein the optics assembly of the slide analyzer further comprises a light filter assembly.

14. The system of claim 1, wherein the optics assembly of the slide analyzer further comprises a magnifier.

15. The system of claim 1, wherein the image receiver of the slide analyzer comprises a CCD or CMOS detector array.

16. The system of claim 1, wherein the image analyzer of the slide analyzer comprises a processor adapted to analyze images taken by the image receiver to determine the number and type of blood cells present in the blood sample.

17. The system of claim 1, wherein the slide analyzer further comprises a memory module coupled to the image processor for storing images taken from the at least two sampling chambers through the optics assembly and the image receiver.

18. The system of claim 1, wherein the slide analyzer further comprises a communications module coupled to the image processor for communicating at least one of images taken from the at least two sampling chambers through the optics assembly and the image receiver and or analysis data thereof to an external source.

19. The system of claim 18, wherein the communications module communicates with the external source through at least one of telemetry, a satellite connection, a wireless connection, the Internet, e-mail, text messaging, or the like.

20. The system of claim 19, wherein the external source comprises a processor adapted to analyze the images communicated from the communications module of the slide receiver.

21. The system of claim 1, wherein the system is configured for use by a non-professionally trained user.

22. A method for determining the number and type of blood cells in a sample, the method comprising:
collecting a blood sample of less than or equal to 5 uL through an inlet of a slide;
channeling the blood sample into a first sampling chamber and a second sampling chamber;
receiving the slide in a slide analyzer;
acquiring an image of the first sampling chamber of the slide analyzer;
acquiring an image of the second sampling chamber of the slide analyzer;
analyzing the image of the first sampling chamber to determine at least one of the number and size of red blood cells in the blood sample; and
analyzing the image of the second sampling chamber to determine the number or type of white blood cells in the blood sample.

23. The method of claim 22, further comprising sending the image of the first sampling chamber and the image of the second sampling chamber with a communications module of the slide analyzer to an external location, wherein the images of the first and second sampling chambers are analyzed with a processor at the external location.

24. The method of claim 22, wherein the slide analyzer comprises a movable slide receiver for receiving the slide,
wherein acquiring the image of the first sampling chamber comprises moving the slide receiver so that the first sampling chamber is in optical alignment with an optics assembly of the slide assembly, and
wherein acquiring the image of the second sampling chamber comprises moving the slide receiver so that the second sampling chamber is in optical alignment with an optics assembly of the slide assembly.

25. The method of claim 22, wherein channeling the blood sample into a first chamber and a second chamber further comprises channeling the blood sample into a third chamber.

26. The method of claim 25, further comprising:
acquiring an image of the third sampling chamber; and
analyzing the image of the third sampling chamber to determine the number of platelets in the blood sample.

27. The method of claim 26, further comprising sending the image of the third sampling chamber to the external location with a communications module of the slide analyzer, wherein the image of the third sampling chamber is analyzed with a processor at the external location.

28. The method of claim 22, wherein the collected blood sample has a volume of less than or equal to 2 uL.

29. The method of claim 22, wherein a first predetermined volume of the blood sample is channeled into the first sampling chamber and a second predetermined volume of the blood sample is channeled into the second sampling chamber.

30. The method of claim 22, further comprising automatically focusing imaging optics of the slide analyzer to focus on bottom surfaces of the first sampling chamber and second sampling chamber before acquiring the images of the first sampling chamber and the second sampling chamber.

31. The method of claim 27, wherein the communications module communicates with the external source through at least one of telemetry, a satellite connection, a wireless connection, the Internet, e-mail, text messaging, or the like.

32. The method of claim 22, further comprising mixing at least one of a surfactant, a dying agent, a lysing agent, a dry form reagent, a liquid reagent, or a predetermined volume of a diluents present in the first or second chamber with the blood sample channeled into the first and second chambers.

33. The method of claim 32, further comprising lysing red blood cells in the second chamber with the lysing agent before analyzing the image of the second sampling chamber with the processor of the slide analyzer to determine the number or type of white blood cells in the blood sample.

34. The method of claim 33, wherein the lysing agent is selected from the group comprising SDS, saponins, snake venom, quaternary ammonium salts, triton-X, and the like.

35. The method of claim 32, wherein the dying agent comprising a nucleic acid staining agent, and wherein analyzing the image of the second sampling chamber with a processor of the slide analyzer to determine the number or type of white blood cells in the blood sample comprises:
staining the white blood cells in the second sampling chamber with the nucleic acid staining agent;
determining a relationship between fluorescence at a first color with fluorescence at a second color for individual white cells of the white blood cells in the sampling chamber; and
determining the type of the individual white blood cell based on the determined relationship.

36. The method of claim 35, wherein the nucleic acid staining agent comprises one or more of acridine orange, thiozole orange, acridine red, 7-AAD, LDS 751, and hydroxystilbamidine.

37. The method of claim 22, further comprising illuminating the first and second sampling chambers before or during the acquiring of the images of the first and second sampling chambers.

38. The method of claim 22, further comprising calibrating the slide analyzer before acquiring the images of the first and second sampling chambers.

39. The method of claim 38, wherein calibrating the slide analyzer comprises acquiring an image of a calibration chamber of the slide analyzer, analyzing the image of the calibration chamber to determine the number or type of cell reproductions in the calibration chamber, and comparing the determined number or type of cell reproductions with a predetermined number or type to determine the accuracy of the slide analyzer.
